(19) United States
(12) Patent Application Publication
(10) Pub. No.: US 2009/0314592 A1
(43) Pub. Date: Dec. 24, 2009

(54) DAMPER DEVICE AND MANUFACTURE OF SUCH A DAMPER DEVICE

(75) Inventor: Nils-Göran Nygren, Huddinge (SE)

Correspondence Address: KNOBBE MARTENS OLSON & BEAR LLP, 2040 MAIN STREET, FOURTEENTH FLOOR, IRVINE, CA, 92614, US

(73) Assignee: OHLINS RACING AB, Upplands Vasby (SE)

(21) Appl. No.: 12/293,473

(22) PCT Filed: Mar. 16, 2007
(86) PCT No.: PCT/SE07/00262

§ 371 Date: Sep. 18, 2008

(30) Foreign Application Priority Data
Mar. 20, 2006 (SE) 0600629-0

(51) Int. Cl. F16F 9/34

(52) U.S. Cl. 188/266.6

(57) ABSTRACT

A damper device is manufactured from a single integrated body. The damper device comprises a damping chamber portion, a valve housing portion with adjustable valve devices and a pressurization reservoir portion. The internal volume of the damping chamber portion is divided by a piston into a compression chamber and a return chamber and the internal volume of the pressurization reservoir portion is divided by a member that is acted upon by a pressure that pressurizes the damping medium in the device. The three different portions are arranged substantially parallel to one another and the internal volume of the valve housing is connected both to the pressurized interior of the pressurization reservoir and to both chambers of the damping chamber part so that the damper always functions with a positive pressure in both the compression and the return chamber. The body is extruded as a single workpiece with alternating heat-conducting channels and fins on its outer surface.

### CROSS-REFERENCE TO RELATED APPLICATIONS

This application claims the benefit and priority to and is a U.S. National Phase of PCT International Application No. PCT/SE2007/000262, filed on Mar. 16, 2007, designating the United States of America and published on Sep. 27, 2007 as WO 2007/108747 in the English language, which claims priority under 35 USC 119 to Swedish Application No. 0600629-0, filed on Mar. 20, 2006. The disclosures of the above-referenced applications are hereby expressly incorporated by reference in their entireties.

### BACKGROUND OF THE INVENTION

1. Field of the Invention

The present invention generally relates to a damper device in the form of a shock absorber in which a piston acts in a damping medium in order to damp movement between wheels and chassis of a vehicle. More particularly, the present invention relates to a damper device in which three chambers are formed in parallel with the middle chamber connecting the outer chambers and one of the outer chambers defining a damping chamber while the other of the outer chambers defines a pressurization chamber.

2. Description of the Related Art

Vehicles used under extreme ambient conditions, such as over difficult terrain, in heat and in dust, place heavy demands on shock absorbers. In order to be able to absorb a large amount of damping energy efficiently, the shock absorber must have a long stroke. Owing to the high damping forces, the damper must be able to withstand high load stresses. It must also have a good cooling capacity in order to rapidly dissipate the damping energy that is converted into heat during movement of the damper. High damping forces result in large pressure drops over the piston, which increase the risk of cavitation. In cavitation, gas bubbles are formed in the damping medium, which can lead to a reduction in the damping forces.

Prior dampers include a damper disclosed in U.S. Pat. No. 3,103,993 A1, for example, which demonstrates a shock absorber with cooling flanges to increase the service life and to improve the functioning of the damper. The damper body comprises a single part with radial fins intended to increase the cooling area. The damper body has four bored cavities. The first bored cavity is the actual damping chamber. The second bored cavity is used as a chamber for pressurizing the damper while handling the displacement generated by the piston rod and the temperature fluctuations caused by changes in volume. The third bored cavity and the fourth bored cavity are adjustable ports that are used to carry the damping medium expelled by the solid piston from one damping chamber to the other. The damper described above lacks the ability to pressurize the damping medium on both sides of the piston, which means that cavitation can easily occur when the damping medium flows through the flow-restricting third and fourth bore cavities.

U.S. Pat. No. 5,178,239 shows a damper manufactured from an extruded cylinder body. The extrusion comprises holes that are used to lead the damping medium between compression and return chambers when the damper is subjected to a high-speed stroke. The extruded fins increase the heat exchange with the surroundings. The piston divides the damping chamber functions in a tube arranged inside the extruded cylinder body. On the return side of the piston, the damper is pressurized by a gas-filled rubber bladder. The problem with this construction is that the damper is not externally adjustable but has a fixed damping characteristic that can only be modified by dismantling the damper and changing the flow-damping shims in the piston. Pressurization of the damper also occurs on only one side of the piston, which can lead to cavitation problems.

### SUMMARY OF THE INVENTION

In order to obtain a compact, light and strong construction, a damper device can be manufactured from a single part in which there are three through-holes extruded parallel to one another in a body of the damper device. The three holes may have different dimensions and may be used as the damper body, a pressurization reservoir and a valve housing. In order to create a large cooling area and a rigid construction, the extrusion also comprises axial cooling flanges in the outer part of the damper body.

Since the three parts (i.e., the damper body, the pressurization reservoir and the valve housing) are generally parallel to one another, connecting ports can be arranged between the internal spaces of the different parts. Placing valve devices at either end of the valve housing and connecting the space between the valve devices to the pressurized space in the pressurization reservoir creates a damper that functions with a positive pressure in both the compression chamber and the return chamber. Because a positive pressure build-up prevails, the likelihood of cavitation can be reduced while the damping force characteristic in both stroke directions can be adjusted separately and independently of each another with the external adjustments.

In some configurations, the valve devices are located concentrically apart at either end of the valve housing part. This location of the valve devices facilitates the transport of damping medium between the two damping chambers and allows an easy external adjustment of the valve devices. In addition, to simplify manufacture, valve devices of identical design can be used for compression damping and for return damping.

Locating the valve devices close to the compression and return chambers makes it possible to create large port areas, which means that the flow resistance of the damping medium to and from the valves is minimized.

In some constructions, the valve devices comprise an external high-speed adjustment and an external low-speed adjustment. This means that one of these two adjustments influences the pressure drop under large flows (i.e., during higher piston rod speeds) and the other influences the pressure drop primarily under small flows (i.e., during lower piston rod speeds). The first adjustable restrictor, i.e. the high speed adjustment, can be adjusted by a screw device on which a spring holder is mounted with the position of the spring holder determining the spring tension on the valve cone. The other adjustable restrictor, i.e. the low-speed adjustment, can be adjusted by a valve that functions as a needle valve in which the through-flow area is determined by the position of the needle. This restrictor is therefore substantially entirely static.

Positioning the cone and the spring inside the valve seat simplifies machining and affords lower product manufacturing costs because the valve seat is relatively sunken and no machining of the valve is required inside the valve seat space.

### BRIEF DESCRIPTION OF THE DRAWINGS

Certain features, aspects and advantages of an embodiment of the present invention will be described in more detail below with reference to the attached drawings, in which:

FIG. 1 schematically shows the damper clamped in a vehicle.

FIG. 1a shows a top plan view of the damper.

FIG. 1b shows a bottom plan view of the damper.

FIG. 2 shows the damper in cross section taken along the section line A-A in FIG. 1b.

FIG. 3 shows a detailed view of one of the valves.

### DETAILED DESCRIPTION OF THE PREFERRED EMBODIMENT

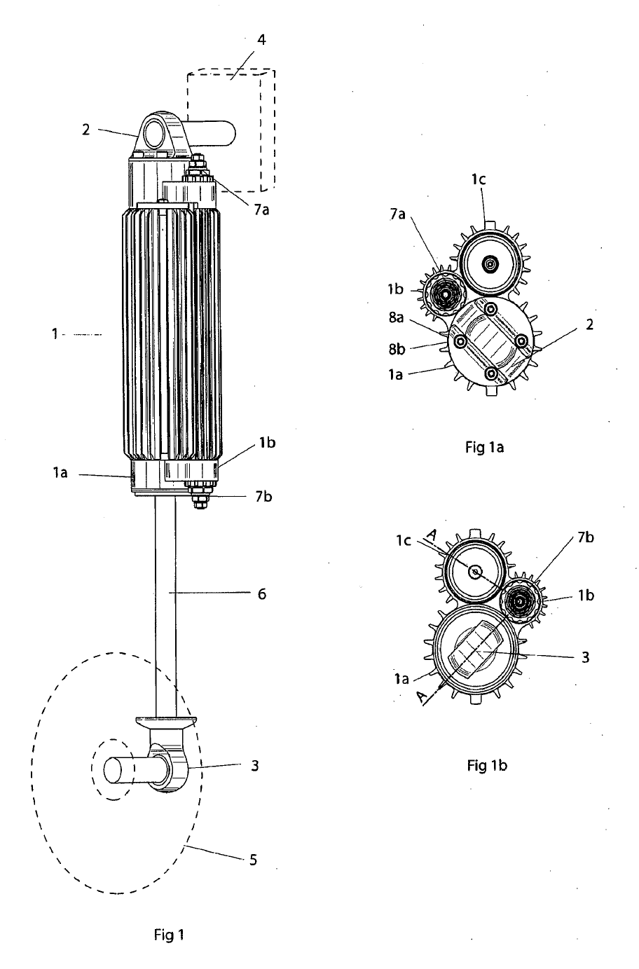

FIG. 1 shows a damper device comprising a body 1, an upper eye 2 of which is fixed to a portion of a vehicle chassis 4 and a lower eye 3 of which is fixed to a wheel mounting 5. Mounting of the damper device is shown only schematically in the drawing. In some configurations, more than one damper can be used for each wheel in conjunction with most suitable types of known wheel suspension arrangements provided that there is sufficient space. The illustrated damper device preferably is used together with a spring element, such as a leaf spring or a coil spring. For example, the coil spring can be placed around another supplementary shock absorber.

The lower eye 3 is fitted to a piston rod 6, which moves in and out of the damper body 1a during relative movements between the chassis 4 and the wheel 5. Also visible in FIG. 1 are valve devices 7a, 7b, which are mounted in line, apart from one another at either end of a valve housing 1b.

FIG. 1a shows a top plan view of the damper in which the three parts of the body 1 (i.e., the damper body 1a, the valve housing 1b and the pressurization reservoir 1c) can be clearly seen. The three parts 1a, 1b, 1c are arranged in cavities connected by common walls. In other words, the body 1 preferably comprises the three parts and more preferably is manufactured from a single workpiece. The workpiece preferably comprises a light-weight material having good thermal conduction properties, such as an aluminum alloy, for example. The outer surface of the body 1 preferably has alternating channels 8a and fins 8b. The channels 8a and fins 8b preferably are produced together with the internal through-cavities of the three parts 1a, 1b, 1c by extrusion of the basic workpiece.

The channels 8a and the fins 8b help to provided a larger overall external area (i.e., a larger surface area), which increases the cooling surface in contact with the surroundings. Moreover, the channels 8a and the fins 8b increase the rigidity of the walls such that the walls of the body 1 can be made thinner whilst maintaining strength and rigidity in certain directions.

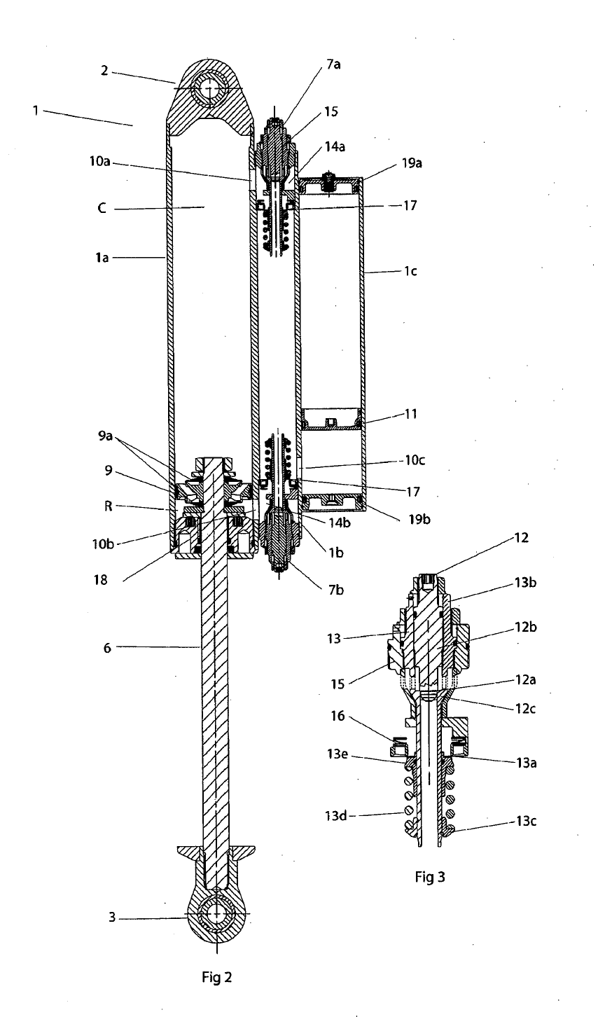

After extrusion, the body 1 can be machined, for example, so that the different parts 1a, 1b, 1c can have different heights from one another or so that the parts 1a, 1b, 1c can have a partially smooth outer surface. Threads and/or locking ring grooves also can be machined into the end parts of the through-cavities. Moreover, sealing closures can be secured with the threads so that each cavity can be defined relative to the surroundings. See FIG. 2 in which the sealing closures 18, 19a, 19b are shown more clearly. The sealing closure 18 seals the lower part of the damper body and the closures 19a, 19b define the interior of the pressurization reservoir 1c relative to the surroundings. The top eye 2 can be defined within one such sealing closure, which is firmly screwed into the damper body 1a in the illustrated configuration. In addition, the valve devices 7a, 7b also can be firmly screwed into the damper body 1a.

FIG. 1b shows a bottom plan view of the damper. Thus, FIG. 1b shows the end eye 3 and the return valve device 7b. The substantially centered location of the compression valve device 7a in the valve housing 1b is shown in FIG. 1a.

FIG. 2 shows the damper in cross section along the section line A-A in FIG. 1b. The damping chamber 1a is divided into two damping chambers (i.e., a compression chamber C and a return chamber R) by a piston 9 which is mounted on the piston rod 6. During piston rod movements, the piston 9 moves so that the damping medium (with which the damper device is filled) is forced either through valves formed in the piston 9. In other words, the medium is forced through a gap that is created between flexible shim washers 9a and the piston 9 or out to the valve housing 1b through ports 10a, 10b as controlled by the external adjustable valve devices 7a, 7b.

From the valve housing 1b, the medium returns to the damping chamber via check valves 16. The term check valve as used herein refers to a valve that allows medium to flow in one direction more than in an opposite direction. The difference in flow in the two directions normally is great because the flow in one direction is often close to zero. In the main flow direction of the valve, the pressure drop is usually significantly lower than in the valve system that generates the damping force. In certain cases, however, a pressure drop can be purposely built in but it should be marginally lower than the set gas pressure in order to reduce the likelihood of cavitation.

The check valves 16 ensure that the pressure in the damping chamber, whether it is the compression side C or the return side R, is always considerably high than the atmospheric pressure in the intended speed range of the damper. When the pressure in the C/R damping chamber in which the lowest pressure prevails drops to the pressure prevailing in pressurization reservoir 1c, the check valve 16 coupled to this C/R chamber opens and pressurized damping medium is led into this C/R chamber. The pressure in the low-pressure C/R chamber, the damping chamber that for the moment has the lowest pressure, is therefore always positive and is well above the atmospheric pressure so that the likelihood of cavitation can be greatly reduced.

Were it not for the pressure drop that occurs in the ports and check valves, the pressure in the C/R low-pressure chamber would never be less than the pressure in the pressurization reservoir 1c. As a result of the changes in volume caused by the piston rod displacement, a certain proportion of the damping medium is also transported via a port 10c to/from the pressurization reservoir 1c. The ports 10a, 10b connecting the internal volumes of the damping chamber 1a and the valve housing 1b are arranged next to the two ends of the damping chamber 1a so the damping medium has the ability to flow into the internal volume of the valve housing 1b via the respective valve device 7a, 7b with the least possible loss of internal stroke.

The internal volume of the valve housing 1b always has a pressure close to the pressure prevailing in the pressurization reservoir 1c because a further port 10c connects this volume to the internal volume of the pressurization reservoir 1c.

The internal volume of the pressurization reservoir 1c may be divided by a floating piston 11, which is acted upon by a pressure generated, for example, by a gas or a mechanical pressure member, such as a spring (not shown). The floating piston 11 can also be replaced by a pressurized rubber bladder or corresponding device for the pressurization of medium.

FIG. 3 shows an enlarged view of one of the valve devices 7a, 7b. The valve device 7a, 7b comprises an external high-speed adjustment device 13 and an external low-speed adjustment device 12. Thus, the valve devices 7a, 7b are so designed that both of the valves comprise an adjustment device 13 that influences the pressure drop in the case of large flows (i.e., a high-speed adjustment) and an adjustment device 12 that influences the pressure drop mainly in the case of small flows (i.e., a low-speed adjustment) in such a way that the damping medium flows through a first adjustable restrictor 13a when the relative movement of the damper is high and through a second adjustable restrictor 12a when the relative speed is low. The low-speed restrictor 12a also has an effect on the high-speed restrictor, albeit to a small degree in percentage terms.

The first adjustable restrictor 13a, i.e. the high-speed adjustment, is adjusted via a screw device 13b, the position of which determines the relative distance between a spring holder 13c and a valve cone 13e. A spring 13d is arranged between the spring holder 13c and the valve cone 13e and the relative distance between the spring holder 13c and the valve cone 13e adjusts the force that is required in order to open the valve cone 13e to allow the damping medium to pass through. The valve cone 13e bears against a valve seat 13f when it is closed. The check valve 16 opens as soon as the pressure inside the valve housing 1b, which owing to the connecting port 10c is equal to the pressure in the pressure reservoir, has a pressure greater than in the respective C/R damping chamber. The other adjustable restrictor 12, i.e. the low-speed adjustment, is adjusted via a valve 12b that functions as a needle valve in which the through-flow area 12a is determined by the position of the needle against the seat 12c. The seat 12c is arranged on a part of the high-speed adjustment device 13. Despite this, the setting of the respective valve is not changed by the adjustment. In addition, compression damping can be adjusted without affecting the return damping and vice versa.

The valve seat 13f, being the seat for the valve cone 13e on one side and the seat for the check valve 16 on the other, bears against a shelf 17 turned in the inner surface of the valve housing. The fact that the spring 13d is arranged in the internal volume of the valve housing inside the valve seat, rather than on top of the valve seat, as in previously known valves, means that the machining of the shelf 17 can be carried out with a shorter tool protrusion than previously possible. This valve design construction therefore simplifies machining and makes product cheaper to manufacture.

In the illustrated damper device, the pressure drop created over the piston 9 as a result of an externally acting force causes the damping medium to flow via the flow-restricting shims 9a and the valve device 7a, 7b to the other side of the piston 9. All valves generating a damping force in both valve movement directions (e.g., comprising shim washers 9a on the main piston, an externally adjustable low-speed valve 12 and an externally adjustable high-speed valve 13) are connected in parallel. Thus, the flow resistance through the valves divides the flow of damping medium between the different valves. The damping medium that does not pass through the valve in the piston 9 flows into a space 14a, 14b defined between the valve cone 13e and the sealing closure 15 that forms a seal between the valve and the surroundings. Depending on the rate of flow and the adjustment setting, the damping medium can flow through the restrictor 12a and/or 13a into the internal volume of the valve housing 1b.

Because the internal volume of the valve housing 1b is connected to the pressurized space in the pressurization reservoir 1c via the port 10c, the same pressure prevails in both volumes. When this pressure is greater than the pressure in any of the C/R damping chambers, the check valve 16 is opened and pressurized damping medium flows into the C/R chamber where the lowest pressure prevails.

Since both of the valve devices 7a, 7b function in the same way, identical valves can be used for both the compression and the return stroke but adjustment of the flow in both directions can be performed independently of one another.

1-12. (canceled)

13. A damper device comprising a single integrated body that defines in substantially parallel relationship a damping chamber, a valve housing and a pressurization reservoir, the damping chamber being divided by a piston into a compression chamber and a return chamber, the piston fixed to a piston rod, a first adjustable valve device and a second adjustable valve device fluidly connected to an internal volume of the valve housing, the pressurization reservoir being divided by a moveable member that is adapted to be acted upon by a pressure that pressurizes damping medium in the damper device, the internal volume defined by the valve housing being connected both to an interior of the pressurization reservoir and to the compression chamber and the return chamber of the damping chamber by the first and second adjustable valve devices.

14. The damper device as claimed in claim 13, wherein an outer surface of the single integrated body comprises longitudinal structures that increase a surface area of the outer surface.

15. The damper device as claimed in claim 14, wherein the longitudinal structures comprise alternating channels and fins.

16. The damper device as claimed in claim 13, wherein the first adjustable valve device is arranged at a first end of the valve housing and the second adjustable valve device is arranged at a second end of the valve housing, wherein the first end is opposite of the second end.

17. The damper device as claimed in claim 16, wherein the first and second adjustable valve devices comprise a first adjustable restrictor and a second adjustable restrictor, the first adjustable restrictor being adapted to adjust high speed damping and the second adjustable restrictor being adapted to adjust low speed damping.

18. The damper device as claimed in claim 17, wherein a check valve bears against a valve seat at each of the first and second adjustable valve devices, the check valves each being interposed between the internal volume of the valve housing and the damping chamber such that the internal volume of the valve housing is in fluid communication with the damping chamber through the check valves as soon as a pressure inside the valve housing is greater than that found within either the compression chamber or the return chamber of the damping chamber.

19. The damper device as claimed in claim 18, wherein the valve seat bears against a shelf formed in an inner surface of the valve housing.

20. The damper device as claimed in claim 17, wherein the first adjustable restrictor is adjusted by a screw device, the position of which determines a relative distance between a spring holder and a valve cone, a spring being arranged between the spring holder and the valve cone and the relative distance between the spring holder and the valve cone adjusting a force that is required in order to open the valve cone and allow damping medium through the first adjustable restrictor.

21. The damper device as claimed in claim 17, wherein the second adjustable restrictor is adjusted via a valve in which the through-flow area is determined by a position of a needle relative to a seat.

22. The damper device as claimed in claim 13, wherein the damping chamber, the valve housing and the pressurization reservoir are arranged in through-cavities extruded as a single workpiece and ports extend between the damping chamber and the valve housing and between the valve housing and the pressurization reservoir.

23. The damper device as claimed in claim 22, wherein the three cavities and longitudinal structures along an outer surface of the damper device are produced by extrusion.

24. The damper device as claimed in claim 23, wherein at least one structure is formed at an end of at least one of the through-cavities, a sealing closure being received in the at least one structure.

25. The damper device as claimed in claim 24, wherein the through-cavity defining the valve housing is sealed at each end by the first and second adjustable valve devices respectively.
